(19) United States
(12) Patent Application Publication
(10) Pub. No.: US 2012/0078570 A1
(43) Pub. Date: Mar. 29, 2012

(54) MULTIPLE ACCELEROMETER SYSTEM

(75) Inventors: Fletcher Rothkopf, Los Altos, CA (US); Phillip Hobson, Menlo Park, CA (US); Adam Mittleman, Portola Valley, CA (US); Anna-Katrina Shedletsky, Sunnyvale, CA (US)

(73) Assignee: Apple Inc., Cupertino, CA (US)

(21) Appl. No.: 13/238,767

(22) Filed: Sep. 21, 2011

Related U.S. Application Data
(60) Provisional application No. 61/387,817, filed on Sep. 29, 2010.

(51) Int. Cl. G06F 15/00

(52) U.S. Cl. 702/141

(57) ABSTRACT

Systems and methods for approximating angular velocity using a plurality of accelerometers are disclosed. In particular, in one embodiment, a method of approximating angular velocity including receiving linear acceleration information from a plurality of accelerometers and calculating a relative acceleration for at least one pair of the plurality of accelerometers is disclosed. The method includes obtaining a distance value for the at least one pair of the plurality of accelerometers and approximating the angular velocity by multiplying the distance value by the relative acceleration to obtain.

### CROSS-REFERENCE TO RELATED APPLICATIONS

The present application claims the benefit under claims benefit under 35 U.S.C. §119(e) to U.S. Provisional Patent Application 61/387,817, filed Sep. 29, 2010 and titled “Multiple Accelerometer System,” the disclosure of which is hereby incorporated herein in its entirety.

### BACKGROUND

1. Technical Field

The present disclosure relates generally to electronic devices and, more specifically, to electronic devices implementing multiple accelerometers.

2. Background

Gyroscopes and accelerometers are two types of motion sensitive sensor that are used to sense movement of devices ranging from vehicles to portable electronic device. However, accelerometers and gyroscopes provide different information and are generally used for different purposes. Generally, gyroscopes generate signals related to angular momentum that may be used in orientation and navigation. In contrast, accelerometers generate signals related to linear acceleration that may be used to sense vibration shock and orientation relative to gravity, among other things. Additionally, gyroscopes generally are larger and more expensive than accelerometers. Furthermore, in some portable electronic devices, the operation of gyroscopes mounted to a common logic board with a speaker may be impacted by mechanical noise resulting from the operation of the speaker. In particular, the logic board may have a resonance in an audible range that causes mechanical noise in the board which is, in turn, transferred to the gyroscope, thus rendering the gyroscope ineffective.

Portable electronic devices have become nearly ubiquitous and are trending toward increasingly more functionality and/or increasingly smaller size. Unfortunately, additionally functionality may come at a cost. In particular, added functionality generally means addition of one or more components resulting in increased cost to manufacture the device. Moreover, space provision for the additional components may increase the size of the device.

### SUMMARY

Aspects of the present disclosure relate to approximation of angular velocity to provide virtual gyroscopic functionality. In particular, in one embodiment, a method of approximating angular velocity including receiving linear acceleration information from a plurality of accelerometers and calculating a relative acceleration for at least one pair of the plurality of accelerometers is disclosed. The method includes obtaining a distance value for the at least one pair of the plurality of accelerometers and approximating the angular velocity by multiplying the distance value by the relative acceleration to obtain.

Another aspect relates to a system configured to approximate angular velocity. In particular, in one embodiment, the system includes a housing with first and second accelerometers positioned therein. The second accelerometer is positioned a known distance from the first accelerometer. A processor is provided that is configured to receive acceleration signals from each of the first and second accelerometers and calculate a relative acceleration value. Additionally, the processor is configured to use the relative acceleration and the known distance to approximate angular velocity.

Yet another aspect relates to determining a position of a device by approximating angular velocity. In one embodiment, a method for determining a position of a device includes obtaining linear acceleration data from a plurality of accelerometers associated with the device and computing a relative acceleration value for each axis of at least one pair of the plurality of accelerometers. A distance value representing the distance between the at least one pair of the plurality of accelerometers is then obtained and multiplied with the relative acceleration values to approximate angular acceleration. The approximated angular acceleration is used to determine a movement of the device.

### BRIEF DESCRIPTION OF THE DRAWINGS

FIG. 1 is a block diagram of an example electronic device having multiple accelerometers.

FIG. 2. graphically illustrates angular momentum of a mass and an approximate relationship between linear acceleration and angular velocity.

FIG. 3 shows the electronic device of FIG. 1 with an example arrangement of the multiple accelerometers.

FIG. 4 illustrates the multiple accelerometers of FIG. 3 as being three-axis accelerometers mounted in a common plane.

FIG. 5 is a flowchart illustrating a method of using multiple accelerometers for dead reckoning of the device's location.

FIG. 6 illustrates an example device having two accelerometers offset from an axis of rotation.

FIG. 7 illustrates the electronic device of FIG. 3 showing axes of rotation that pass through no more than two accelerometers.

FIG. 8. illustrates the electronic device of FIG. 3 showing possible common axes of rotation.

FIG. 9 illustrates a top view of a vehicle having two accelerometers positioned therein.

FIG. 10 is a flowchart illustrating a method of using multiple accelerometers to track movement.

FIG. 11 is a flowchart illustrating a method for implementing accelerometer redundancy for angular velocity approximation.

### DETAILED DESCRIPTION

Certain aspects of the present disclosure relate to providing an approximation of angular velocity using multiple accelerometers. That is, multiple accelerometers are implemented to provide gyroscopic functionality. In some embodiments, the multiple accelerometers are implemented in an electronic device to obtain linear acceleration information that is used to approximate angular velocity. In particular, the angular velocity (or angular rate, in degrees per second) may be computed using software that provides a numerical value corresponding to the angular velocity and an integrated rate (over a designated period of time) which has units of degrees per second per second to applications that make use of the gyroscopic functionality.

The approximation of angular velocity includes computing a linear acceleration differential between linear acceleration signals of the accelerometers. A known distance between the accelerometers is used with the linear acceleration differential to compute an approximate angular velocity signal. As the approximation does not involve complex mathematical operations, it is generally not burdensome to a processor.

The approximated angular velocity information may be used for orientation and navigation of the electronic device. Generally, the use of multiple accelerometers is cheaper and requires less space relative to implementing a gyroscope. Additionally, as many electronic devices already have accelerometers installed, the addition of one or more additional accelerometers incurs minimal costs in the manufacturing process.

In some embodiments, two accelerometers may be implemented in an electronic device. The two accelerometers may be mounted on a printed circuit board (PCB) of the electronic device and located at opposite ends of the PCB to provide a maximum distance between the two accelerometers. The distance between the two accelerometers is known. Each accelerometer obtains acceleration data which is provided to a processor of the device. The processor determines a relative acceleration (e.g., a difference between the acceleration data obtained by the accelerometers in each of several axes). The relative acceleration is used with the distance between the accelerometers to determine or approximate the angular velocity of the device. The angular velocity may be used for orientation and/or navigation for the device, among other things.

In some embodiments, the accelerometers may be positioned in or near opposite corners of the device to achieve maximum distance between the accelerometers. Additionally, the accelerometers may be offset from likely axes of rotation. The offset helps to avoid a situation where an axis of rotation intersects both accelerometers and coincides with the vector of gravitational acceleration. In such a scenario, the linear acceleration differential may be indeterminable.

In some embodiments, additional accelerometers may be implemented. For example, a third accelerometer may be implemented. The third accelerometer may be spaced apart from the other accelerometers in a manner to maximize the distance therebetween. In some embodiments, the third accelerometer is also positioned so that it does not coincide with an axis of rotation that includes more than one of the other accelerometers. Additionally, the third accelerometer may be positioned so that it is not within a possible common axis of rotation.

In addition to providing gyroscopic functionality, the use of multiple accelerometers provides for redundant accelerometer functionality. For example, some electronic devices may be configured to automatically rotate the orientation of a display between landscape and portrait based on the input from an accelerometer. Should one accelerometer fail, a redundant accelerometer may be used to supply the information for the autorotation functionality (e.g., orientation relative to gravity). Moreover, the use of three or more accelerometers provides for redundant gyroscopic functionality. If one of the accelerometers fails, there may still be at least two other accelerometers to provide the gyroscopic functionality. Furthermore, when three or more accelerometers are functioning, the multiple measurements may be used to calculate an average approximate angular velocity that may help to reduce the effect of outlier measurements.

Although the present disclosure is described herein with respect to particular systems and methods, it should be recognized that certain changes or modifications to the embodiments and/or their operations may be made without departing from the scope of the disclosure. Accordingly, the proper scope of the disclosure is defined by the appended claims and the various embodiments, operations, components, methods and configurations disclosed herein are exemplary rather than limiting in scope.

Referring to FIG. 1, a block diagram of an example electronic device 100 having multiple accelerometers is illustrated. The electronic device 100 may be implemented as one of a number of electronic devices such as a notebook computer, a navigation device, a smart phone, a personal digital assistant, a cellular phone, or the like. The electronic device 100 may include a processor 102, a memory 104, a display 106, input/output devices 108, and accelerometers 110, 112, 114. The processor 102 may be a suitable processor implemented in electronic devices, such as the A4 processor from Apple Inc.®. The memory 104 is coupled to the processor 102 and may be configured to store executable instructions and data for the use by the processor 102. In particular, the memory 104 may store instructions and data related to approximating angular velocity from linear acceleration information. The memory 104 may be implemented in one or more common memory platforms such as random access memory, flash, and so forth. The display 106 and the I/O devices 108 may also be coupled to the processor 102 and may be configured to provide output to a user and/or receive input from a user or other devices. For example, the display 106 may be a touch screen display that includes touch sensors, such as capacitive touch sensors, to receive user input.

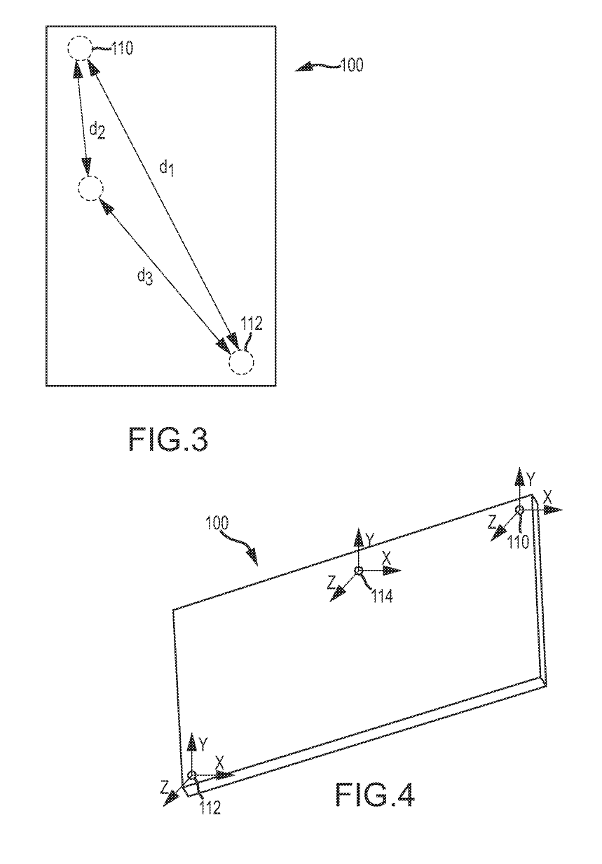

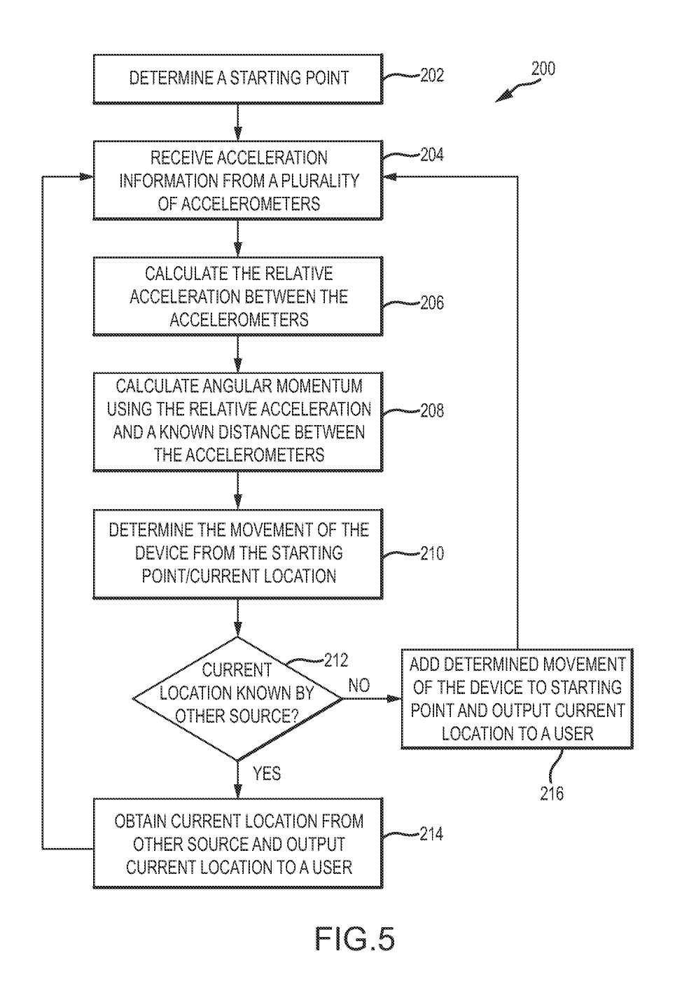

FIG. 3 illustrates the accelerometers 110, 112, 114 within the electronic device 100. The respective distances between the accelerometers 110, 112, 114 are indicated as d₁, d₂ and d₃. As illustrated, accelerometers 110, 112 are located in or near opposite corners of the device 100. This maximizes the distance d₁ between the accelerometers to help increase the ability to sense differences in relative acceleration. The distance between the accelerometers is a known value that is used for relating the output of the accelerometer to angular velocity. FIG. 4 illustrates the accelerometers 110, 112, 114 as being three-axis accelerometers having a common orientation. That is each of the respective axes of the accelerometers are aligned so that the information related to each axis may be directly compared with the information of the same axis of another accelerometer without manipulation of the information to account for misalignment of the axes.

Three axis gyroscopes provide angular velocity information in three axes. Hence, gyroscope information from a three axis gyroscope may be represented as:

$$[ gyroscope ] = [ \begin{matrix}{Ω}_{x} \\ {Ω}_{y} \\ {Ω}_{z}\end{matrix} ] , \qquad ( 1 )$$

where Ω is angular velocity, Ωₓ is the angular velocity in the x-axis, Ω_{y} is the angular velocity in the y axis, and Ω_{z} is the angular velocity in the z axis. Angular velocity is represented as:

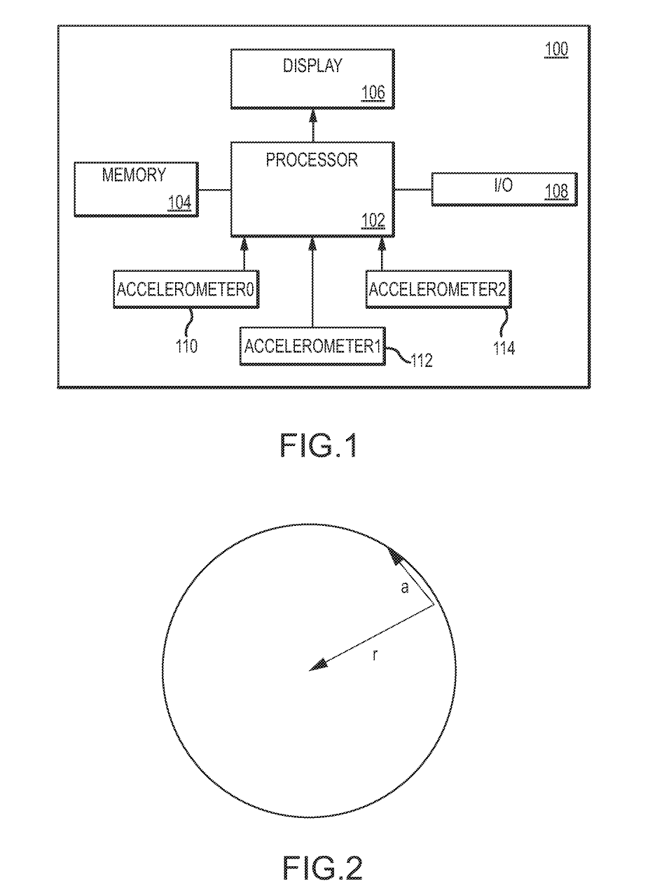

Ω=(r)(a), (2)

where “r” is the radius of rotation and “a” is angular acceleration, as shown graphically in FIG. 2. More particularly, FIG. 2 illustrates a mass “M” having angular acceleration a about a curvature having a radius r. Thus, acceleration is related to angular velocity by the distance r.

Generally, an accelerometer provides magnitude and directional acceleration information in the form of vectors. Acceleration information from a three axis accelerometer may be represented as:

$$[ accelerometer ] = [ \begin{matrix}{a}_{x} \\ {a}_{y} \\ {a}_{z}\end{matrix} ] , \qquad ( 3 )$$

where aₓ is an acceleration vector in the x-axis, a_{y} is an acceleration vector in the y-axis, a_{z} is an acceleration vector in the z-axis. When two accelerometers are implemented, such as accelerometers 110 and 112, a relative or differential acceleration (aᵣₑₗ) may be determined. That is, a difference in the acceleration information from each accelerometer may be determined according to the equation:

$$[ {a}_{rel} ] = [ {a}_{1} ] - [ {a}_{2} ] = [ \begin{matrix}{a}_{1 x} \\ {a}_{1 y} \\ {a}_{1 z}\end{matrix} ] - [ \begin{matrix}{a}_{2 x} \\ {a}_{2 y} \\ {a}_{2 z}\end{matrix} ] . \qquad ( 4 )$$

The distance between the two accelerometers may be used to determine the angular velocity according to the equation:

$$Ω = [ {a}_{rel} ] [ d ] = [ \begin{matrix}{Ω}_{x} \\ {Ω}_{y} \\ {Ω}_{z}\end{matrix} ] , \qquad ( 5 )$$

where d represents the distance between the accelerometers and replaces the radius term of the angular momentum equation (2) above.

The accelerometers (e.g., accelerometers 110 and 112) may be positioned apart from each other to help increase the sensitivity to relative acceleration. For example, the accelerometers may be positioned in opposite corners of an electronic device. This helps to increase the difference in acceleration of the accelerometers. If the accelerometers were to be positioned adjacent to each other, the differential acceleration would be negligible unless the axis or rotation was near one or both of the accelerometers (e.g., if the axis of rotation coincided with one of the accelerometers but not the other accelerometer).

The use of the multiple accelerometers to approximate angular velocity information affords dead reckoning capabilities without the use of a gyroscope. A method 200 for using multiple accelerometers for dead reckoning is illustrated in the flowchart of FIG. 5. The method may be implemented in a device such as the electronic device 100 of FIG. 1. The method 200 begins by determining a starting point or current location of the device (Block 202).

The starting point may be determined from a global positioning service (GPS) device, user input, or other sources. For example, the device may receive input from a GPs device. In some embodiments, a GPS device may be integrated with a multipurpose device such as smart phone, for example. In other embodiments, a user may indicate a location, such as an address. A compass may additionally be implemented to provide bearings. Specifically, upon receiving location information from a user or GPS, the compass may help determine a direction that device is oriented.

From the starting point, movement of the device is tracked using the accelerometers to approximate angular velocity of the device. Each accelerometer senses acceleration (Block 204) in three axis. The acceleration from each accelerometers is used to determine a relative acceleration (Block 206). Angular velocity is then approximated by multiplying the relative acceleration with the known distance between the accelerometers (Block 208). The angular velocity may be used to determine the movement of the device and from the starting point (Block 210).

In some embodiments, the device may be configured to check if a current position may be determined through other means. For example, in some embodiments, the device may be configured to periodically poll a GPS device to find a current position. In other embodiments, the device may be configured to request user input to set a current location. As such, the device may be configured to determine if updated current location information is available (Block 212). If it is available, the device may supplant the starting point with the current location information (Block 214). If it is not available, the device may continue to track the movement of the device using information obtained from the accelerometers (Block 216).

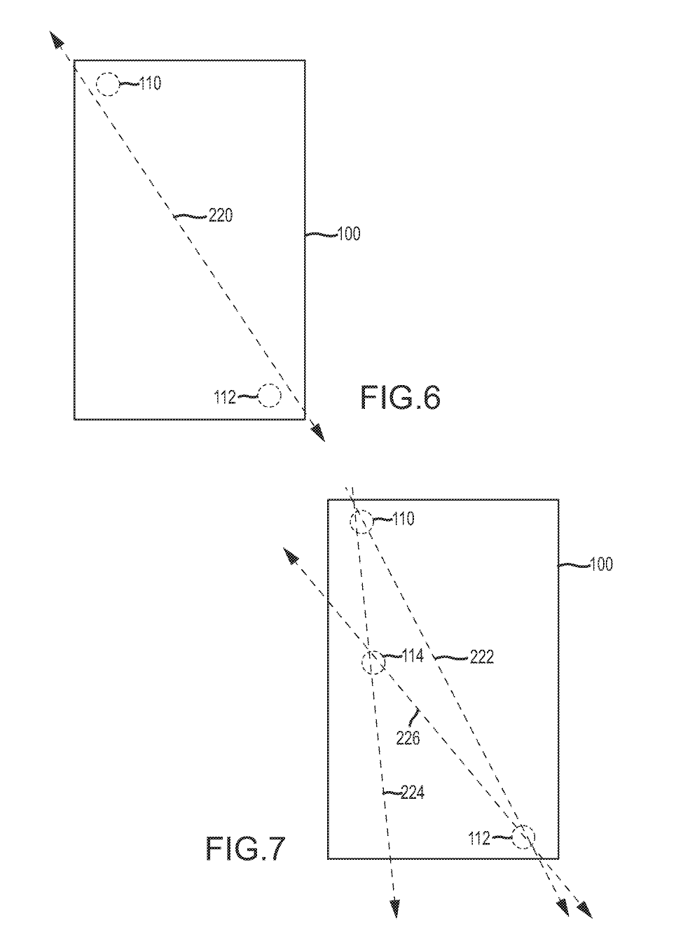

In the multiple accelerometer embodiments disclosed herein, the accelerometers may be positioned so that they are not aligned within a possible common axis of rotation. For example, as illustrated in FIG. 6, accelerometers 110 and 112 may be offset from their respective corners. In some embodiments, at least one or both of the accelerometers may be offset from the corners, as an axis of rotation 220 is more likely to occur through a corner than at an offset from the corner. This prevents a case where the device 100 may be held in a way that the axis of rotation is aligned with the pull of gravity with both accelerometers being within the axis of rotation. In such a case, the accelerometers would be ineffectual for sensing the movement of the device.

In instances where three accelerometers are implemented, they may be positioned such that there is no axis of rotation 222, 224, 226 in which all three accelerometers reside, as shown in FIG. 7. Hence, with strategic positioning of the accelerometers 110, 112, 114, no more than two accelerometers may reside in a common axis of rotation.

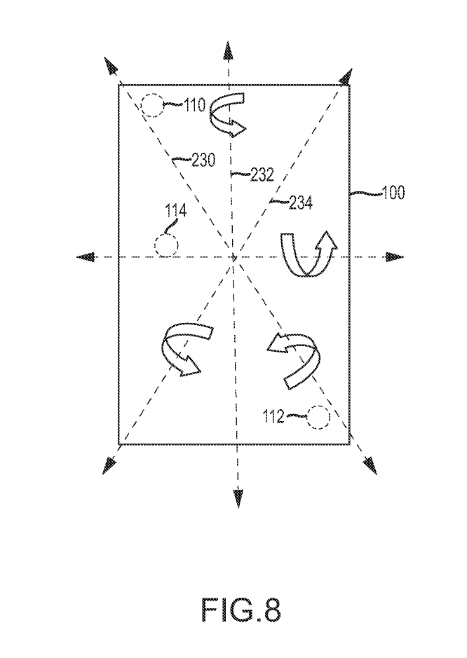

FIG. 8 illustrates some of the possible common axes of rotation which include axes of rotation 230, 232, 234 passing through the corners of the device 100, and through the middle of the device, both across the device and length wise. As shown, the accelerometers 110, 112, 114 are positioned such that the common axes of rotation do not intersect the accelerometers.

Multiple accelerometers may be implemented in a vehicle such as a car or an airplane to provide orientation and navigation functionality without using a gyroscope. In such applications, the distance between the accelerometers may be extended further than in a portable electronic device, thus providing for increased sensitivity of relative movement of the accelerometers.

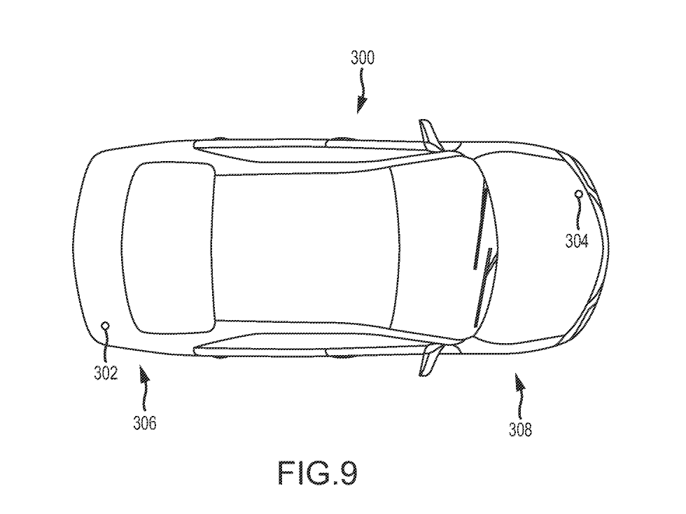

FIG. 9 illustrates a vehicle 300 having multiple accelerometers positioned thereon for navigational purposes. In particular, the vehicle 300 has a first accelerometers 302 located near the rear 306 of the vehicle and a second accelerometer 304 located near its front end 308. The accelerometers 302, 304 may be positioned at opposite corners of the vehicle 300, as illustrated, or in other suitable configurations.

When the vehicle 300 is moving, the accelerometers 302, 304 sense the acceleration and may be used to approximate angular acceleration as discussed above. However, the linear acceleration signals provided from the accelerometers 302, 304 may frequently be similar due to the vehicle moving in a single direction (i.e., forward or backward). In such cases, the differences between the accelerometer readings may cancel each other out when determining the relative acceleration. In such cases, the approximation of angular acceleration may be eliminated and the linear acceleration may be read directly from the accelerometers.

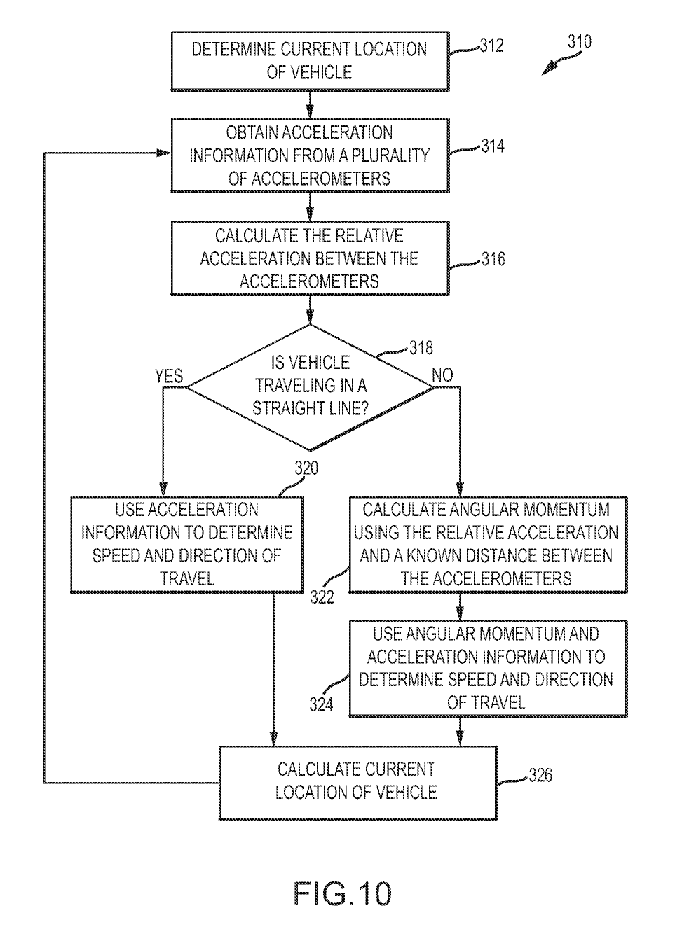

FIG. 10 is a flowchart illustrating a method 310 of determining location of a moving vehicle using multiple accelerometers. The method 310 may be initiated by determining a current location and/or orientation (Block 312). As discussed above, the current location and/or orientation may be provided by a user, a GPS, and/or a compass.

Acceleration information is periodically obtained from the accelerometers (Block 314). A relative acceleration is then determined (Block 316). The relative acceleration is determined by subtracting the acceleration information from one accelerometer from the accelerometer of the other accelerometer for each axis. A determination is then made as to whether the relative acceleration indicates that the vehicle is generally traveling in a straight line (Block 318). This determination may be made based on the relative acceleration being compared to a threshold. The threshold may be a percentage of the total acceleration or a particular acceleration value. For example, if the relative acceleration is less than 1% of one or both of the acceleration information obtained from the accelerometers, or if the relative acceleration is less than 1 mm/sec², it may be determined that the vehicle is generally moving in a line.

Additionally, the accelerometers 302, 304 may be oriented so that the an axis aligned traverse to a primary travel direction of the vehicle. That is, an axis of the accelerometers may be aligned across the vehicle to be sensitive to turning of the vehicle. In some embodiments, the threshold may be applied to the acceleration information of that axis exclusively, so that determinations may be based on the vehicle making turns or otherwise changing directions.

If it is determined that the vehicle 300 is traveling in a generally straight line, no determination as to angular acceleration is made. In particular, the acceleration information may be used to determine the rate of travel of the vehicle and the direction of the travel is determined to be forward or reverse based on the direction indicated by the acceleration vectors provided from the accelerometers (Block 320).

However, if it is determined that the vehicle is not traveling in a straight line, the relative acceleration is used to approximate the angular acceleration by multiplying the relative acceleration by the distance between the accelerometers (Block 322). The acceleration information is then used with the angular velocity information to determine the speed and direction of travel (Block 324). The position of the vehicle is then determined (Block 326) and the method 310 is repeated.

Although two accelerometers are shown in FIG. 9, in other embodiments, three or more accelerometers may be implemented to provide redundancy. The redundancy may be useful if an accelerometer is not functioning properly and/or to aid in obtaining a more accurate approximation of angular velocity. For example, in some embodiments, angular velocity may be approximated based on measurements of a first pair of accelerometers that includes first and second accelerometers, a second pair of accelerometers including a first accelerometer of the first pair of accelerometers and a third accelerometer, and a third pair of accelerometers that includes the second and third accelerometers. The angular velocity approximations may be compared to determine any variance and based on the variance it may be determined to eliminate acceleration information from one of the accelerometers or to average the angular acceleration information.

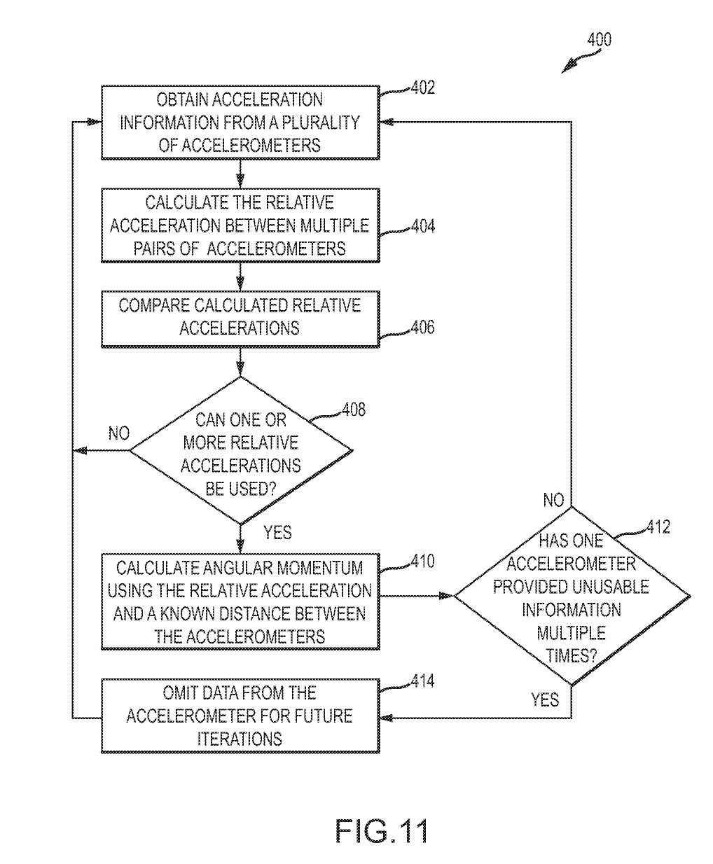

FIG. 11 is a flowchart illustrating a method (400) for approximating angular acceleration using redundant pairs of accelerometers. Initially, linear acceleration information is obtained from each of the accelerometers (Block 402). A relative acceleration is then determined for multiple pairs of accelerometers (Block 404). For example, if three accelerometers provided acceleration information, relative acceleration may be determined for at least two pairs of accelerometers (e.g., a first pair including a first accelerometer and a second accelerometer, and a second pair including a third accelerometer and the first accelerometer).

The relative accelerations from the multiple pairs may be compared (Block 406). In some instances, the relative accelerations may be too small to exceed threshold error range and thus may not be conducive to obtaining a meaningful reading. Thus, a determination is made as to whether the relative acceleration from one or more accelerometer pair is usable (Block 408). If no relative acceleration value may provide a meaningful reading, the method starts over.

In some embodiments, the relative accelerations may be compared against each other. As the accelerometers are located in different positions, the relative accelerations are expected to be different. In some embodiments, the larger value relative acceleration may be used. In some embodiments, the relative acceleration values may be compared against a threshold. The threshold may be set to a value that when exceeded is indicative of movement that should be accounted for, but that when not exceeded indicates that an axis of rotation may run through both of the accelerometers of the pair or that there is insignificant movement. If more than one relative acceleration exceeds the threshold, the relative accelerations may be averaged together.

The relative acceleration from one or more accelerometer pair is then used to approximate the angular velocity (Block 410). A determination may be made after multiple iterations whether one of the accelerometers is not functioning properly (Block 412). For example, if a relative acceleration value from one accelerometer is unusable for multiple sequential iterations (e.g., if the relative acceleration is below a threshold repeatedly), the linear acceleration data from that accelerometer may be omitted from future iterations (Block 414). This may provide increased reliability and save processing resources.

The approximation of angular velocity from acceleration data allows for a multiple accelerometers system to operate as a virtual gyroscope. That is the approximated angular velocity may be substituted for the angular velocity information that a gyroscope would provide. As the accelerometers are generally cheaper and not susceptible to the same interference as gyroscopes, devices may be provided with the gyroscopic functionality without the cost, size accommodation issues, or other issues associated with implementing a gyroscope.

1. An angular velocity approximation system comprising:
a housing;
a first accelerometer positioned within the housing;
a second accelerometer positioned within the housing a known distance from the first accelerometer; and
a processor coupled to the first and second accelerometers and configured to receive acceleration signals therefrom, the processor is further configured to calculate a relative acceleration value and multiply the relative acceleration with the known distance to approximate angular velocity.

2. The angular velocity approximation system of claim 1 further comprising a third accelerometer positioned within the housing a first distance from the first accelerometer and a second distance from the second accelerometer.

3. The angular velocity approximation system of claim 1 wherein the first and second accelerometers comprise three-axis accelerometers.

4. The angular velocity approximation system of claim 1 wherein the housing comprises a rectangular shape and the first and second accelerometers are positioned near opposite corners of the housing.

5. The angular velocity approximation system of claim 4 wherein the third accelerometer is located near another corner of the housing.

6. The angular velocity approximation system of claim 4 wherein at least one of the first and second accelerometers is offset from an axis that passes through the opposite corners.

7. The angular velocity approximation system of claim 1 further comprising at least one of a global positioning device, a compass, and a user input device.

8. The angular velocity approximation system of claim 1 further comprising a display configured to provide a graphical output that indicates a location based at least in part on the approximated angular velocity and a known starting point.

9. A method of approximating angular velocity comprising:
receiving linear acceleration information from a plurality of accelerometers;
calculating a relative acceleration for at least one pair of the plurality of accelerometers;
obtaining a distance value for the at least one pair of the plurality of accelerometers; and
approximating the angular velocity by multiplying the distance value by the relative acceleration to obtain.

10. The method of claim 9 further comprising:
determining a starting point; and
determining a current location using the approximation of angular velocity and the starting point.

11. The method of claim 9 further comprising calculating a plurality of relative accelerations.

12. The method of claim 11 further comprising determining if one or more of the plurality of relative accelerations provide meaningful information.

13. The method of claim 12 wherein approximating the angular velocity comprises calculating an average of the one or more of the plurality of relative accelerations that provide meaningful information.

14. The method of claim 12 further comprising:
determining if one of the plurality of accelerometers has provided unusable information for multiple iterations; and
omitting information from the one of the plurality of accelerometers that has provided unusable information.

15. The method of claim 13 wherein determining if one or more of the plurality of relative accelerations provide meaningful information comprises comparing the plurality of relative accelerations to a threshold.

16. The method of claim 13 wherein determining if one or more of the plurality of relative accelerations provide meaningful information comprises comparing the plurality of relative accelerations to each other.

17. A method for determining a position of a device comprising:
obtaining linear acceleration data from a plurality of accelerometers associated with the device;
computing a relative acceleration value for each axis of at least one pair of the plurality of accelerometers;
obtaining a distance value representing the distance between the at least one pair of the plurality of accelerometers;
multiplying the distance value with the relative acceleration values to approximate angular acceleration; and
using the approximated angular acceleration to determine a movement of the device.

18. The method of claim 17 further comprising:
obtaining a first position and orientation of the device; and
determining a current position of the device by adding the determined movement of the device to the first position.

19. The method of claim 17 further comprising determining if the device is traveling in a straight line.

20. The method claim 19 further comprising using the linear acceleration data to determine a speed and direction of travel of the device if it is determined that the device is traveling in a straight line.
